(19) United States
(12) Patent Application Publication
(10) Pub. No.: US 2022/0022510 A1
(43) Pub. Date: Jan. 27, 2022

(54) AGGLOMERATED COMPOSITION COMPRISING AN EDIBLE SOLID PARTICULATE COMPONENT AND A POTATO STARCH

(71) Applicant: Conopco Inc., d/b/a UNILEVER, Englewood Cliffs, NJ (US)

(72) Inventors: Thomas Jürgen Kinkelin, Neuendettelsau (DE); Susanne Kerstin Merkl, Igensdorf (DE); Joachim Romann, Heilbronn (DE); Winfried Rupp, Bretzfeld-Rappach (DE)

(73) Assignee: Conopco Inc., d/b/a UNILEVER, Englewood Cliffs, NJ (US)

(21) Appl. No.: 17/299,319

(22) PCT Filed: Nov. 21, 2019
(86) PCT No.: PCT/EP2019/082090

§ 371 Date: Jun. 3, 2021

(30) Foreign Application Priority Data
Dec. 20, 2018 (EP) 18214402.2

(51) Int. Cl. A23L 29/212

(52) U.S. Cl. CPC A23L 29/212

(57) ABSTRACT

The objective of the present invention is to provide a composition containing an edible solid particulate component, for example a starch, which is free from additives like maltodextrin, lactose and flowability improvers. Nevertheless, the removal of such additives should not lead to inferior qualities of such composition when in use. The objective of this invention is to provide an alternative to such additives, which has a natural image for consumers, and which can lead to benefits like good dissolution of the starch, no clumping during dissolution, good flowability of a dry mixture in a factory, and which does not lead to a dusty dry powder mixture. This problem has been solved by agglomerating an edible solid particulate component, preferably containing a starch, with particulate, expanded, gelatinized potato starch, to create a dry, particulate, agglomerated composition. The combination of these ingredients leads to improvement of the free-flowability of such mixture, and/or decrease of the dustiness and/or improvement of the solubility of a mixture comprising such ingredients.

### FIELD OF THE INVENTION

The present invention relates to an agglomerated composition comprising a particulate, expanded, gelatinized potato starch and an edible solid particulate component. The invention further relates to a method for preparation of such agglomerated composition. Additionally, the invention relates to use of a particulate, expanded, gelatinized potato starch to improve the flowability and/or decrease dustiness and/or improve the agglomeration and/or improve the solubility of such agglomerated compositions.

### BACKGROUND TO THE INVENTION

Maltodextrin is used in many agglomerated savoury food products to adhere different ingredients together and build up the agglomerates. In addition, it is used as a flowability and filler agent in mainly all dry savoury products. There is a desire among food manufacturers to remove maltodextrin from their compositions, due to negative consumer perception in some regions.

Combinations of starch and maltodextrin are used in many dry food applications like soups or sauces as binding agent (starch) and flowability, solubility improvement ingredient (maltodextrin). Dry combinations of these compounds are widely available, as sauce binders. Maltodextrin cannot easily be removed from such mixtures, as maltodextrin serves as an adhesion material for agglomeration with starches. The agglomeration process may not function properly in case maltodextrin is excluded from agglomerated recipes, due to the missing adhesion material. Moreover, maltodextrin serves as a flowability agent. Excluding maltodextrin from dry mixes may lead to significant decrease of the flowability of the mixture, and processability on the filling line will be negatively impacted. Maltodextrin additionally serves as a solubility agent: excluding maltodextrin may decrease solubility of the mixture, once used in hot or boiling water. Such composition may also contain other flow aid, which serves to improve the flowability of a dry powder containing such ingredients.

Such compositions may also contain lactose, adding sweetness, and functional as a spacer between starch and maltodextrin molecules. Therewith solubility of such a composition can be further improved. Nevertheless, the presence of lactose may not always be beneficial, because of its sweetness, providing calories, and the possible sensitivity for many people for lactose. Such people may not be able to split lactose into its two monomers, and therewith are not able to digest lactose completely.

EP 0 087 847 A1 relates to a process for preparing foamed gelatinized starch products, for example the particulate, expanded, gelatinized potato starch as used in the present invention.

EP 0 910 957 A2 relates to a water-binding composition for binding the excess liquid after cooking high-carbohydrate, starchy foods, such as rice, potatoes, pasta, cereals, legumes, etc. The composition comprises 20-60% by weight of a physically modified starch, 35-65% by weight of a chemically modified starch, and 2-15% by weight of a dried edible fat emulsion. The physically modified starch can be for example Aero-Myl from Südstärke (Germany).

US 2010/0028496 A1 relates to a dry powder composition for reducing the sodium chloride content in food products. Such a dry composition may contain physically modified starch Aero-Myl from Südstärke as flow auxiliary.

WO 2004/108767 A2 relates to relates to a new instantized/agglomerated pregelatinized (either cold water swelling or traditional pregel) starch and to its preparation and use in the preparation of a variety of products requiring complete starch dispersion and rapid viscosity development with little or no stirring. More specifically, this relates to pre-gelatinized starch on which a coating has been applied. The coating can be prepared from gum arabic, 1-octenyl succinic anhydride treated gum arabic, 1-octenyl succinic anhydride treated starches, 1-octenyl succinic anhydride treated maltodextrins, 1-octenyl succinic anhydride treated dextrins, and mixtures of any two or more of these. An expanded, gelatinized potato starch is not used in here.

EP 1 166 645 A2 relates to an agglomerated starch-based product based on starch and maltodextrin, and dry mixes for food preparations containing the agglomerated starch-based product.

EP 1 241 216 A1 relates to a thickening composition comprising a ‘co-processed’ combination of modified starch and flour.

### SUMMARY OF THE INVENTION

Because of the disadvantages of dry compositions containing starch, maltodextrin, lactose and possibly other flow aids, there is a desire to remove these additives from the dry mixtures containing starches. Nevertheless, the removal of such additives should not lead to inferior qualities of such composition when in use. The objective of this invention is to provide an alternative to such additives, which has a natural image for consumers, and which can lead to benefits like good dissolution of the starch, no clumping during dissolution, good flowability of a dry mixture in a factory, and which does not lead to a dusty dry powder mixture.

This problem has been solved by agglomerating an edible solid particulate component, preferably containing a starch, with particulate, expanded, gelatinized potato starch, to create a dry, particulate, agglomerated composition.

Such agglomerated dry composition has as advantages that it is well soluble, not dusty, and rapidly dissolving. The particulate, expanded, gelatinized potato starch is physically modified and has similar agglomeration properties as maltodextrin. The agglomeration of an edible solid particulate component with a particulate, expanded, gelatinized potato starch leads to a composition which is dry, in particulate form, and free-flowing. Consequently, flowability improvers like maltodextrin or any other flowability agents can be excluded from recipes. Moreover, lactose is not required either, which means that the product becomes suitable to be used by people who are intolerant to lactose. Therefore, the particulate, expanded, gelatinized potato starch can be used as an ingredient to remove other additives from the composition (maltodextrin, lactose).

Further advantages of the particulate, expanded, gelatinized potato starch are that it has no influence on colour, taste and flavour and that it does not contribute to additional thickening in application (similarly as maltodextrin). So this material is an expanded material, which provides a glueing effect in agglomeration, as well as a spacing effect like lactose.

Accordingly, in a first aspect the invention provides a composition comprising from 5% by weight to 75% by weight of a particulate, expanded, gelatinized potato starch and 25% to 95% by weight of an edible solid particulate component, and wherein the composition is in an agglomerated, particulate, dry form.

In a second aspect the invention provides a method for preparation of a composition according to the first aspect of the invention, comprising the steps:
a) preparing a homogeneous mixture comprising from 5% by weight to 75% by weight of a particulate, expanded, gelatinized potato starch and 25% to 95% by weight of an edible solid particulate component;
b) adding water to the mixture from step a) while mixing;
c) transferring the mixture from step b) to a drier,
d) drying the mixture from step c);
e) discharging the dried and agglomerated mixture from step d) from the drier; and
f) optionally sieving and optionally packing the mixture from step e).

In a third aspect the invention provides use of a particulate, expanded, gelatinized potato starch to improve the flowability and/or decrease dustiness and/or improve the agglomeration and/or improve the solubility of a mixture comprising an edible solid particulate component, and such particulate, expanded, gelatinized potato starch.

### DETAILED DESCRIPTION OF THE INVENTION

All percentages, unless otherwise stated, refer to the percentage by weight (wt %).

“Physically modified starch” means a starch which has been subjected to a heat treatment in the presence of relatively small amounts of water or moisture. No other reagents are added to the starch during the heat treatment. The heat-treatment processes include heat-moisture and annealing treatments, both of which cause a physical modification of starch without any gelatinization, damage to granular integrity, or loss of birefringence (Miyazaki et al., Trends in Food Science & Technology 17 (2006) p. 591-599). Annealing represents ‘physical modification of starch slurries in water at temperatures below gelatinisation’ whereas heat-moisture treatment ‘refers to the exposure of starch to higher temperatures at very restricted moisture content (18-27%)’. (Tester et al., International Journal of Biological Macromolecules 27(2000) p. 1-12). Physical modification should be distinguished from gelatinisation of starch, which usually is carried out by heating starch in an excess amount of water. Other terms which are used for this type of starch are “heat-treated starch” and “heat-modified starch”.

“Enzymatically modified starch” means a starch which has been treated with one or more enzymes to modify its properties.

“Chemically modified starch” means a starch which has been reacted with reagents which have been added to the starch in order to form new covalent bonds between those molecules and the starch molecules.

“Native starch” means a starch which has not been physically, chemically, or enzymatically modified.

Except in the operating and comparative examples, or where otherwise explicitly indicated, all numbers in this description indicating amounts or ratios of material or conditions of reaction, physical properties of materials and/or use are to be understood as modified by the word ‘about’.

The invention provides a composition comprising from 5% by weight to 75% by weight of a particulate, expanded, gelatinized potato starch and 25% to 95% by weight of an edible solid particulate component, and wherein the composition is in an agglomerated, particulate, dry form. With an edible solid particulate component is meant a dry powder containing edible components, e.g. a dry starch that can be used as a food component. Preferably, the agglomerates in the composition of the invention have a size such that at least 90% by weight of the agglomerates pass through a sieve with a mesh size ranging from 1 to 5 millimeter. More preferred at least 90% by weight of the agglomerates pass through a sieve with a mesh size ranging from 1 to 2 millimeter, more preferred from 1 to 1.6 millimeter. Alternatively, preferably at least 90% by weight of the agglomerates pass through a sieve with a mesh size ranging from 1.6 to 5 millimeter.

Whenever reference is made herein to water content, unless indicated otherwise, said water content includes unbound (free) as well as bound water. In the context of the present invention, “dry” means that no unbound free water is present in the composition of the invention. Nevertheless, the powder may contain a certain amount of water, which is bound within the particles of the particulate composition. This means that moisture may be present in the agglomerates. Preferably, the moisture level of the composition ranges from 2 to 10% by weight, preferably from 4 to 8% by weight.

Preferably, the edible solid particulate component has a size such that at least 90% by weight of the agglomerates pass through a sieve with a mesh size of 500 micrometer. More preferred at least 90% by weight of the agglomerates pass through a sieve with a mesh size of 400 micrometer. Preferably, the composition of the invention comprises from 10% by weight to 50% by weight of the particulate, expanded, gelatinized potato starch, and from 50% to 90% by weight of an edible solid particulate component. More preferred, the composition of the invention comprises from 20% by weight to 50% by weight of the particulate, expanded, gelatinized potato starch, and from 50% to 80% by weight of an edible solid particulate component. Even more preferred the composition of the invention comprises from 20% by weight to 30% by weight of the particulate, expanded, gelatinized potato starch, and from 70% to 80% by weight of an edible solid particulate component. There is a balance between the amount of edible solid particulate component and the particulate, expanded, gelatinized potato starch. Too much of the potato starch reduces the thickening effect of the composition, as the potato starch only minorily contributes to the thickening effect of the agglomerates. A too low content of the potato starch reduces the solubility of the agglomerates.

The bulk density of the agglomerated dry composition of the invention preferably ranges from 350 to 600 gram per liter, more preferred from 400 to 550 gram per liter.

The edible solid particulate component may comprise various types of materials. Preferably, the edible solid particulate component comprises one or more compounds selected from native starches, physically modified starches, chemically modified starches, enzymatically modified starches, vegetable powders, and fruit powders.

In case the edible solid particulate component comprises native starch, then preferably the native starch comprises one or more starches selected from corn starch, potato starch, tapioca starch, waxy corn starch, waxy rice starch, and wheat starch.

In case the edible solid particulate component comprises physically modified starch, then preferably the physically modified starch comprises one or more starches selected from corn starch and potato starch, preferably wherein the physically modified starch is a physically modified potato starch.

Therefore, preferably the composition of the invention comprises from 5% by weight to 75% by weight of a particulate, expanded, gelatinized potato starch and 25% to 95% by weight of an edible solid particulate component, wherein the edible solid particulate component is physically modified potato starch, and wherein the composition is in an agglomerated, particulate, dry form.

Preferably, the physically modified starch as used herein has been obtained by treating native starch in a process as described in U.S. Pat. No. 4,418,090 (which is hereby incorporated by reference), comprising the following consecutive steps:
a) heating native starch at a temperature ranging from 55° C. to 135° C., preferably from 90° C. to 120° C. during a time period from 70 to 200 minutes; and
b) drying the mixture from step a) to a water content ranging from 6% to 8% by weight.

Preferably the native starch in step a) has a water content ranging from 15 to 25%, preferably from 19 to 21%. Preferably, the mixture in step a) is heated such that its water level ranges from 13% to 16% by weight. During this step, preferably the water and steam content is lower than required for gelatinisation. This means that preferably the physically modified starch as used is not pre-gelatinised. Therefore, preferably the physically modified starch requires to be cooked-up before it can be used as a thickener in any application.

Preferably the pH of the native starch before the starch is dried is at its natural pH and does not require adjustment. Alternatively, the pH of the native starch before drying is adjusted to a pH which is neutral or basic. Preferably, the pH of the native starch before drying ranges from 7 to 12, preferably from 7.5 to 12, preferably from 8.0 to 10.5. Native starch may be slightly acidic to neutral, and in such case adjustment of the pH preferably is done to a pH within the preferred range. Adjustment of the pH preferably is performed with food-grade bases selected from sodium hydroxide, sodium carbonate, tetrasodium pyrophosphate, ammonium orthophosphate, disodium orthophosphate, trisodium phosphate, calcium carbonate, calcium hydroxide, potassium carbonate, and potassium hydroxide, or any mixture of these bases.

The drying of the starch to the desired moisture level preferably is done simultaneously with the heating of the starch to the required heating temperature.

Instead of the physically modified starches as described herein, also other physically modified starches may be used in the composition of the invention. Examples of such starches are starches from the Novation Endura and Novation Prima range, as supplied by Ingredion Inc. (Westchester, Ill., USA). Other preferred physically modified starches are the physically modified potato starches Puramyl HF 6% ex Avebe (Veendam, Netherlands), and SimPure 99530 ex Cargill (Wayzata, Minn., USA).

In case the edible solid particulate component comprises chemically modified starch, then preferably the chemically modified starch comprises one or more starches selected from corn starch, potato starch, tapioca starch, waxy corn starch, waxy rice starch, and wheat starch, preferably from corn starch, potato starch, tapioca starch, and waxy corn starch.

In case the edible solid particulate component comprises vegetable powders and/or fruit powders, then preferably the vegetable powders and fruit powders comprise one or more powders from tomato powder, spinach powder, onion powder, potato powder, wheat flour, buckwheat flour.

Alternatively, the edible solid particulate component may comprise cream powder, which is spray dried dairy cream, or creamer powder, which is a composition containing vegetable fat and dairy (milk) protein.

Preferably the composition of the invention only comprises the particulate, expanded, gelatinized potato starch and the edible solid particulate component. Preferably the composition is free from other compounds. Hence preferably the composition of the invention consists of from 5% by weight to 75% by weight of a particulate, expanded, gelatinized potato starch and 25% to 95% by weight of an edible solid particulate component, and wherein the composition is in an agglomerated, particulate, dry form. More preferred the composition of the invention consists of from 5% by weight to 75% by weight of a particulate, expanded, gelatinized potato starch and 25% to 95% by weight of an edible solid particulate component, wherein the edible solid particulate component is physically modified potato starch, and wherein the composition is in an agglomerated, particulate, dry form. More preferred the composition of the invention consists of from 5% by weight to 75% by weight of a particulate, expanded, gelatinized potato starch and 25% to 95% by weight of an edible solid particulate component, wherein the edible solid particulate component is physically modified potato starch, and wherein the composition is in an agglomerated, particulate, dry form.

Preferably the composition of the invention is free from additives like maltodextrin, lactose and flowability improvers. Preferably the composition of the invention neither contains maltodextrin, nor lactose or other monosaccharides or disaccharides, nor flowability improvers.

Preferably, the composition of the invention consists of from 10% by weight to 50% by weight of the particulate, expanded, gelatinized potato starch, and from 50% to 90% by weight of an edible solid particulate component. More preferred, the composition of the invention consists of from 20% by weight to 50% by weight of the particulate, expanded, gelatinized potato starch, and from 50% to 80% by weight of an edible solid particulate component. Even more preferred the composition of the invention consists of from 20% by weight to 30% by weight of the particulate, expanded, gelatinized potato starch, and from 70% to 80% by weight of an edible solid particulate component.

The term “particulate, expanded, gelatinized potato starch” as used herein refers to starch that has undergone physical treatment resulting in the crystalline starch structure becoming an amorphous structure. Briefly, gelatinization is a process that breaks down the intermolecular bonds of starch molecules in the presence of water and heat, allowing the hydrogen bonding sites to engage more water. Penetration of water increases randomness in the general starch granule structure and decreases the number and size of crystalline regions. Under the microscope in polarized light starch loses its birefringence and its extinction cross during gelatinization. The extent to which the starch present has an amorphous structure can suitably be determined by cross polarised light microscopy. Expanded, gelatinized potato starch has a lower bulk density than native or pre-gelatinized starch. Preferably the particulate, expanded, gelatinized potato starch has been obtained by a process wherein a granular or pulverized starch or starch-containing materials are heated in an extruder press at temperatures of 60 to 220° C. in the presence of 10 to 30% by weight of water and a gas-forming or gas-generating expanding agent and then extruded.

The amorphous structure of particulate, expanded, gelatinized potato starch can be suitably visualized concentrate by means of XRT (X-ray micro computed tomography, also known as micro-CT) or SEM (scanning electron microscopy). The shattered, amorphous irregular structure lacking in birefringence of the expanded, gelatinized starch particles can suitably be recognised, compared to native (crystalline) starch.

The particle size distribution of the particulate starch component and the particulate, expanded, gelatinized potato starch can suitably be determined by means of sieving, i.e. by employing a set of sieves of different mesh sizes. The sieving may be carried out on the dry particles, but may also be carried out on a relatively dilute dispersion of the particles in a hydrophobic medium, such as for instance a liquid triglyceride oil.

The particulate, expanded, gelatinized potato starch of the present invention can be prepared by extrusion, e.g. by using an extrusion process as described in EP 0 087 847 A1. Preferably, the expanded, gelatinized potato starch is a foamed pregelatinized starch product produced by the process of European patent application EP 0 087 847 A1. Such a process would be performed to obtain the particulate, expanded, gelatinized potato starch, and prior to agglomerating the particulate, expanded, gelatinized potato starch with the edible solid particulate component. In such an extrusion process, a starch material, e.g. starch comprising potato material, is fed into an extruder where the said material is heated in the presence of water and optionally a gas forming expanding agent to gelatinize the starch and to build up pressure. When the heat processed said material leaves the extruder, the pressure drop results in the formation of an extruded, i.e. gelatinized, starch structure. The extruded material can be milled or otherwise comminuted to produce the particulate, expanded, gelatinized potato starch. Preferably, the extruded material is milled or otherwise comminuted to produce the particulate, expanded, gelatinized potato starch.

The content of EP 0 087 847 A1 are incorporated herein by reference.

Preferably, the particulate, expanded, gelatinized potato starch has a particle size such that at least 80% by weight, more preferred at least 90% by weight, and even more preferred at least 95% by weight, of the starch passes a sieve with a mesh size of 1000 micrometer. If the particles of the particulate, expanded, gelatinized potato starch are too large, they are likely to lead to a grainy/gritty mouthfeel upon consumption of the product in which the starch has been used.

Preferably, not more than 15% by weight of the particulate, expanded, gelatinized potato starch passes a sieve with a mesh size of 100 micrometer or less, more preferably not more than 35% by weight of the particulate, expanded, gelatinized starch component pass a sieve with a mesh size of 200 micrometer or less.

The term ‘bulk density’ as used herein, unless indicated otherwise, refers to freely settled bulk density. Preferably, the particulate, expanded, gelatinized potato starch has a bulk density ranging from 50 to 200 gram per liter, preferably ranging from 100 to 180 gram per liter, more preferably ranging from 110 to 160 gram per liter. Preferably, the particulate expanded, gelatinized starch component has a bulk density of at least 50 gram per liter, more preferably at least 80 gram per liter, even more preferably at least 100 gram per liter.

Preferably, the expanded, gelatinized starch component has a bulk density of at most 200 gram per liter, more preferably at most 160 gram per liter.

The particle size and the bulk density of the particulate, expanded, gelatinized potato starch refers to the particle size and the bulk density of this starch prior to being agglomerated with the edible solid particulate component.

An example of a suitable particulate, expanded, gelatinized potato starch is Aero-Myl 33 (ex Südstärke GmbH, Schrobenhausen, Germany). This specific starch preferably is used as the particulate, expanded, gelatinized potato starch.

The composition of the invention can be used as a binder for aqueous compositions, in case it contains a starch as edible solid particulate component. The starch acts as thickener for the aqueous composition. When the agglomerates have been used as a thickener and are dissolved in water, then the agglomerates will not be recognizable as such anymore.

In a second aspect the invention provides a method for preparation of a composition according to the first aspect of the invention, comprising the steps:
a) preparing a homogeneous mixture comprising from 5% by weight to 75% by weight of a particulate, expanded, gelatinized potato starch and 25% to 95% by weight of an edible solid particulate component;
b) adding water to the mixture from step a) while mixing;
c) transferring the mixture from step b) to a drier,
d) drying the mixture from step c);
e) discharging the dried and agglomerated mixture from step d) from the drier; and
f) optionally sieving and optionally packing the mixture from step e).

In step a) the particulate, expanded, gelatinized potato starch and the edible solid particulate component are mixed, preferably in dry form. Any suitable method to mix the two dry powders can be used to prepare this mixture. Preferably no other compounds are added to the mixture of the particulate, expanded, gelatinized potato starch and the edible solid particulate component.

In step b) water is added to the mixture from step a). Preferably, in step b) the amount of water ranges from 10% to 24% of the total amount of particulate, expanded, gelatinized potato starch and edible solid particulate component. More preferred the amount of water ranges from 11% to 22% of the total amount of particulate, expanded, gelatinized potato starch and edible solid particulate component, more preferred from 12% to 20%. The amount of water preferably is such, that the particulate, expanded, gelatinized potato starch is wetted by the amount of water, leading to agglomeration of smaller particles of the potato starch into bigger particles. The water also leads to agglomeration of the potato starch particles with the edible solid particulate component. The water and potato starch act as a glue to bind the edible solid particulate component. A lower amount of water leads to a dusty composition, with many small tiny particles. Higher amounts of water may lead to larger agglomerated particles. Nevertheless, the water should not become too high, as the size of the agglomerates may become too large, which may decrease the solubility of the agglomerates.

Preferably the mixing both the mixing in step a) and step b) is done at a temperature ranging from 10° C. to 30° C. Heating is not required in order to mix these ingredients with water, the mixing preferably can be done at room temperature.

Transfer of the mixture from step b) to a drier in step c) can be done by any suitable method. In step d) the drying can be done with air, without requiring any heating. Alternatively and preferably, the drying in step d) is carried out in a fluid bed drier. The temperature in the fluid bed drier preferably ranges from 50 to 110° C., more preferred from 50 to 90° C. Preferably, the drying is done until the moisture level of the composition ranges from 2 to 10% by weight, preferably from 4 to 8% by weight.

In step e) the dried agglomerates are discharged from the drier by any suitable method. Subsequently in step f) the dried agglomerates are optionally sieved in case a certain particle size is required. Finally, and optionally, the dried agglomerates are packed in any suitable container in order to be able to be marketed to the end-users of the agglomerates.

Preferably no other compounds are present in the composition prepared according to the method of the invention.

Any preferred feature applicable to the first aspect of the invention, is considered to be applicable to this second aspect of the invention as well, mutatis mutandis.

In a third aspect the invention provides use of a particulate, expanded, gelatinized potato starch to improve the flowability and/or decrease dustiness and/or improve the agglomeration and/or improve the solubility of a mixture comprising an edible solid particulate component, and such particulate, expanded, gelatinized potato starch. Preferably the third aspect of the invention provides a method for using a particulate, expanded, gelatinized potato starch to improve the flowability and/or decrease dustiness and/or improve the agglomeration and/or improve the solubility of a mixture comprising an edible solid particulate component, and such particulate, expanded, gelatinized potato starch.

Any preferred feature applicable to the first or second aspect of the invention, is considered to be applicable to the third aspect of the invention as well, mutatis mutandis.

The advantages of the agglomerates are that they are at least as good as or even better soluble than corresponding non-agglomerated mixtures. Moreover, due to the agglomeration, many fine, powdery particles are captured into bigger particles, leading to less dust and easier handling of the dry mixtures. Additionally, the agglomeration leads to compositions which are free-flowing, while the non-agglomerated mixtures of the same ingredients are not free-flowing. The advantage of this is that handling of the dry mixtures is much. Both in production in a factory, the agglomerated mixture can easily be transported from one vessel to the other and dosed into its final packaging material. Also for a consumer a free-flowing powder is much easier to dose than non-free-flowing powders. Therefore, the consumer will rather use these agglomerated mixtures than the corresponding non-free-flowing mixtures, when wanting an easy-to-use thickening composition.

### EXAMPLES

The following non-limiting examples illustrate the present invention.

Raw Materials

Aero-Myl 33 (ex Südstärke GmbH, Schrobenhausen, Germany) is the particulate, expanded, gelatinized potato starch.

HF potato starch (ex Unilever Heilbronn, Germany); prepared in the way as described in U.S. Pat. No. 4,418,090.

### Example 1: Preparation of Agglomerates Using Various Raw Materials and Aero-Myl

Various raw materials were used as edible solid particulate component, as shown in the following table. The general preparation method for these agglomerates was the following:
mixing of 400 g of edible solid particulate component (80 wt %) and 100 g Aero-Myl 33 (20 wt %) in a Thermomix (Vorwerk & Co. Kg, Wuppertal, Germany), to create a homogeneous dry mix at maximum speed (10) for 10 seconds; at room temperature;
addition of 70 g of cold water and mix additionally for 20 seconds with same speed;
the wet mixtures were spread out over a flat plate, which were dried overnight under ambient conditions. After drying the dried agglomerated were sieved to a size smaller than 1.6 mm. All agglomerates which did not pass through a sieve with a size of 1.6 mm were rejected.

Agglomerates were prepared for the following edible solid particulate components. For all materials it was possible to prepare agglomerates:

TABLE 1
Overview of edible solid particulate components to prepare
agglomerates in combination with Aero-Myl 33

| | | |
|---|---|---|
| Edible solid particulate | Description of edible solid | Result of process - description of |
| component | particulate component | agglomerates |

Native starches - Not dried (natural moisture level):

| | |
|---|---|
| Corn | slightly coarse |
| Potato | coarse, very well agglomerated |
| Tapioca | less agglomerated, more water would |
| | be necessary |
| Waxy Corn | less agglomerated, more water would |
| | be necessary |
| Waxy Rice | still less agglomerated, very dusty, |
| | more water would be necessary |
| Wheat | less agglomerated, dusty, much more |
| | water would be necessary |

Physically modified starches:

| | | |
|---|---|---|
| HF potato starch | Dried to 6-8% | coarse, very well agglomerated |
| | moisture | |
| Corn | Dried to 12% | less agglomerated, more water necessary |
| | moisture | |
| Potato | Dried to 12% | slightly coarse |
| | moisture | |

Chemically modified starches (E1404, oxidised starch), dried:

| | |
|---|---|
| Corn | less agglomerated, more water would |
| | be necessary |
| Potato | less agglomerated, more water would |
| | be necessary |
| Tapioca | less agglomerated, more water would |
| | be necessary |
| Waxy Corn | very less agglomerated, powdery/very |
| | dusty, more water would be necessary |

Other edible materials:

| | |
|---|---|
| Tomato powder | very good - |
| Cream powder | very good - uncomplicated (difficult to sieve) |
| Spinach powder | very good - |
| Onion powder | very good - |

### Example 2: Preparation of Agglomerates Using Various Concentrations of HF Potato Starch and Aero-Myl

Agglomerates were prepared using various concentrations of HF potato starch and Aero-Myl 33. The similar process as in example 1 was applied, with varying amounts of these two types of raw materials, as indicated in the following table. In all cases mixing time of dry powders was 10 seconds, and after addition of water to the dry mixture, the mixture was mixed for another 30 seconds.

TABLE 2
Overview of experiments to prepare agglomerates using various
amounts of HF potato starch and Aero-Myl 33 and water.

| Amount of HF | Amount of | Amount of | |
|---|---|---|---|
| potato starch | Aero-Myl 33 | water | |
| [g] | [g] | [g] | Agglomeration result |
| 450 (90 wt %) | 50 (10 wt %) | 50 | slightly agglomerated, |
| 400 (80 wt %) | 100 (20 wt %) | 50 | less dusty, coarse, well agglomerated, |
| | | | more water could be added |
| 350 (70 wt %) | 150 (30 wt %) | 50 | less dusty, coarse, very well agglomerated, |
| | | | more water could be added |
| 300 (60 wt %) | 200 (40 wt %) | 50 | still less dusty than sample before, |
| | | | coarse, very well agglomerated, |
| | | | slightly more water could be added |
| 250 (50 wt %) | 250 (50 wt %) | 50 | still less dusty than sample before, |
| | | | coarse, well agglomerated, slightly |
| | | | more water could be added |
| 250 (50 wt %) | 250 (50 wt %) | 100 | coarse, no dust anymore |
| 250 (50 wt %) | 250 (50 wt %) | 150 | too much water, after 20 sec. no |
| | | | agglomerates anymore, rather |
| | | | like a paste/dough |
| 250 (50 wt %) | 250 (50 wt %) | 125 | better than sample before but |
| | | | still too much water |

These experiments show that with increasing Aero-Myl content with constant water amount, the granularity of the agglomerates increases, the number of very fine particles (dust) decreases, and solubility increases. Better quality agglomerates are obtained. Additionally the experiments with 50% HF potato starch and 50% Aero-Myl and increasing amounts of water show that the granularity of the agglomerates increases, the number of very fine particles (dust) decreases, and better quality agglomerates are obtained.

### Example 3: Solubility of Agglomerates of HF Potato Starch and Aero-Myl

Various agglomerates of HF potato starch and Aero-Myl 33 were prepared, to test the influence of the ratio between HF potato starch and Aero-Myl.

The solubility test was done in the Thermomix (Vorwerk & Co. Kg, Wuppertal, Germany) in the following way:
take 1 liter of boiling water, add 15 g pure HF potato starch while stirring and boil for 1 minute;
add an agglomerated sample (see table 3) at level 7 while stirring for 30 seconds;
boil without stirring for 30 seconds;
boil again while stirring for 30 seconds and at least let it boil for 30 seconds without stirring;
add 1 liter hot water and sieve;
residue in sieve is the amount of lumps; The lower

The following agglomerates were prepared, as indicated in the following table. The absolute amount of HF potato starch was kept constant while the concentration of Aero-Myl was varied. This was done in order to have the same concentration of HF potato starch in the solubility test, leading to the same thickness of the aqueous mixture. The Aero-Myl does not contribute to the thickness of the aqueous mixture.

Agglomerates of HF potato starch and Aero-Myl were prepared following the same procedure as described in example 1. The agglomerates were added to the solubility test in amounts as indicated in the following table, and the amount of lumps after this test was determined:

TABLE 3
Overview of experiments to test solubility of agglomerates
using various amounts of HF potato starch and Aero-Myl 33.

| | | Amount of | |
|---|---|---|---|
| | | agglomerates | Amount of |
| Amount of HF | Amount of | added to | lumps after |
| potato starch | Aero-Myl 33 | solubility test | sieving |
| [g] | [g] | [g] | [g] |
| 500 (100 wt %)* | 0 (0 wt %) | 10.6 | 9.3 |
| 450 (90 wt %) | 50 (10 wt %) | 13.1 | 7.3 |
| 400 (80 wt %) | 100 (20 wt %) | 15.7 | 5.0 |
| 350 (70 wt %) | 150 (30 wt %) | 18.2 | 0 |
| 250 (50 wt %) | 250 (50 wt %) | 23.4 | 0 |

*agglomeration process is applied, however without the Aero-Myl

By varying the amount of agglomerates, the total amount of HF potato starch in the solubility test is constant in each experiment, namely 15.0 g+10.6 g=25.6 g. Increasing the amount of Aero-Myl in the agglomerates leads to less lump formation, thus to better solubility of the agglomerates and the HF potato starch.

### Example 4: Solubility of Agglomerates of HF Potato Starch or Corn Starch and Aero-Myl or Maltodextrin

Various agglomerates of HF potato starch or Maizena corn starch and Aero-Myl 33 or maltodextrin (as comparison) were prepared and tested on solubility (lump formation).

Raw Materials:
HF potato starch and Aero-Myl 33 as described before;
Maizena corn starch (Maizena Maisstärke, Unilever Austria GmbH, Austria).

Agglomerates were prepared following basically the same process as in example 1. The following ingredients and water were used, in the amounts as indicated.

TABLE 4
Preparation of agglomerates with various ingredients.

| | Amount of HF | Amount of | Amount of | Amount of | Amount of |
|---|---|---|---|---|---|
| | potato starch | Corn starch | Aero-Myl 33 | maltodextrin | water |
| Agglomerate | [g] | [g] | [g] | [g] | [g] |
| A | 400 | | 100 | | 50 |
| B | 400 | | | 100 | 50 |
| (comparative) | | | | | |
| C | | 400 | 100 | | 50 |
| D | | 400 | | 100 | 50 |
| (comparative) | | | | | |

Preparation of mixtures was done in Thermomix, as indicated before. The mixing times were the following:
dry mixture of powders: 10 seconds at speed 10
during water addition: 10 seconds at speed 10
during agglomeration: 20 seconds at speed 10

After these mixing steps, the agglomerates were dried in the way as described in example 1.

Various tests were done with these agglomerates, and these were compared to the pure HF potato starch and the pure corn starch.

TABLE 5
Analyses and observations about agglomerates from table
4, pure HF potato starch and pure corn starch.

| | Observations about | | Bulk density* |
|---|---|---|---|
| Agglomerate | agglomeration | Free flowability | [g/L] |
| A | slightly powdery | very well | 520 |
| | and dusty | | |
| B | slightly powdery | very well | 563 |
| (comparative) | and dusty | | |
| C | powdery and dusty | better than pure corn starch, | 429 |
| | | not free flowable, worse than | |
| | | agglomerate A | |
| D | powdery and dusty | better than pure corn starch, | 438 |
| (comparative) | | not free flowable, worse than | |
| | | agglomerate A | |
| HF potato starch | powdery and dusty | not free flowable | |
| (comparative) | | | |
| Corn starch | powdery and dusty | not free flowable | |
| (comparative) | | | |

*average of 5 measurements

Solubility tests were performed, similarly as in example 3. The Thermomix as described before was used to do the tests. The following procedure was applied:
take 1 liter hot water, add 15 g of HF potato starch dried and stir at 250 rpm;
heat until water is boiling;
reduce induction heating to level 7 and stir for 1 minute;
add sample of agglomerate or pure starch (as indicated in table below) while stirring for seconds;
let it simmer without stirring at level 7 for 30 seconds;
stir again with speed 250 rpm for 30 seconds, let simmer without stirring for 30 seconds;
sieve and calculate residue.

TABLE 6
Overview of experiments to test solubility of agglomerates
using various amounts of HF potato starch and Aero-Myl 33.

| | Amount of | |
|---|---|---|
| Agglomerate | agglomerates | Amount of lumps |
| or starch | or starch added | after sieving* |
| sample | [g] | [g] |
| A | 15.7 | 13.7 |
| B | 15.7 | 14.1 |
| (comparative) | | |
| C | 15.7 | 39.2 |
| D | 15.7 | 39.1 |
| (comparative) | | |
| HF potato starch | 14.2 | 30.0 |
| (comparative) | | |
| Corn starch | 14.2 | 69.0 |
| (comparative) | | |

*each data point on lump formation is an average of 3 individual measurements

These experiments show:
Aero-Myl is a good replacement for maltodextrin, the solubility of the agglomerates is the same or even slightly better (less lump formation) when made with Aero-Myl;
The solubility of the agglomerates is much better than that of the pure starches.
Agglomerates of starch and Aero-Myl, in particular the HF potato starch (physically modified potato starch) lead to good free-flowing agglomerates, much better than the pure HF potato starch;
Agglomerates of corn starch and Aero-Myl lead to better free flowing compositions than the pure corn starch.

### Example 5: Comparison of Agglomerated and Non-Agglomerated Mixtures of Starches and Aero-Myl

A comparison was made between agglomerated and non-agglomerated mixtures of HF potato starch or Maizena corn starch and Aero-Myl 33 or maltodextrin (as comparison), similarly as in example 4.

The following materials were tested for their solubility (using procedure as in example 4):
Agglomerates A, B, C, D from table 4;
Combination of HF potato starch or Maizena corn starch and Aero-Myl 33 or maltodextrin in the same amounts as in table 4, but without the agglomeration step with water (see table 7 below); dry mixtures of these compounds were prepared in the Thermomix:
Pure HF potato starch or Maizena corn starch;

TABLE 7
Preparation of dry mixtures of potato starch or Maizena
corn starch and Aero-Myl 33 or maltodextrin.

| | Amount of HF | Amount of | Amount of | Amount of | Amount of |
|---|---|---|---|---|---|
| | potato starch | Corn starch | Aero-Myl 33 | maltodextrin | water |
| Agglomerate | [g] | [g] | [g] | [g] | [g] |
| E | 400 | | 100 | | 0 |
| F | 400 | | | 100 | 0 |
| G | | 400 | 100 | | 0 |
| H | | 400 | | 100 | 0 |

None of these mixtures was free flowing, as the ingredient present in majority in the mixture (HF potato starch or corn starch) was not free flowing. Mixing with Aero-Myl or maltodextrin did not help to make the mixtures free flowing.

The solubility (lump formation of all compositions was compared), see table 8:

TABLE 8
Overview of experiments to test solubility of agglomerates
using various amounts of HF potato starch and Aero-Myl 33
(data of samples A, B, C, D, and pure starches from table 6).

| | Amount of | |
|---|---|---|
| | agglomerates | |
| Agglomerate | or mixture | Amount of lumps |
| or starch | or starch added | after sieving* |
| sample | [g] | [g] |
| A | 15.7 | 13.7 |
| E | 15.7 | 14.7 |
| (comparative) | | |
| B | 15.7 | 14.1 |
| (comparative) | | |
| F | 15.7 | 13.6 |
| (comparative) | | |
| C | 15.7 | 39.2 |
| G | 15.7 | 41.1 |
| (comparative) | | |
| D | 15.7 | 39.1 |
| (comparative) | | |
| H | 15.7 | 55.2 |
| (comparative) | | |
| HF potato starch | 14.2 | 30.0 |
| (comparative) | | |
| Corn starch | 14.2 | 69.0 |
| (comparative) | | |

*each data point on lump formation is an average of 3 individual measurements

These data show that the agglomeration of HF potato starch with Aero-Myl or corn starch with Aero-Myl as compared to the same mixtures without the agglomeration steps leads to about the same amounts of lumps being formed (compare A to E and C to G). The agglomeration leads to slightly less lump formation, although this may not be significantly different. Nevertheless, the trend is that the lump formation is lower for the agglomerates with Aero-Myl than for the corresponding non-agglomerated mixtures with Aero-Myl.

And additionally, the agglomeration leads to free-flowing agglomerates (see table 5, in particular the agglomerates with HF potato starch). The non-agglomerated mixtures are not free-flowing. In particular this free-flowing of the agglomerates leads to benefits for handling of the agglomerates: both in production on a factory, it is much easier to dose and transport agglomerated compositions. Also for a consumer/end-user it is much easier to dose free-flowing powders: the correct amount of agglomerates as required for thickening can easily be dosed by the consumer. The experiments also show that just addition of Aero-Myl is not sufficient to improve the flowability of the starches: only the agglomeration leads to a really free-flowing composition, in particular for the combination of Aero-Myl and physically modified potato starch.

1. A composition comprising from 5% by weight to 75% by weight of a particulate, expanded, gelatinized potato starch and 25% to 95% by weight of an edible solid particulate component, and wherein the composition is in an agglomerated, particulate, dry form.

2. The composition according to claim 1, wherein the expanded, gelatinized potato starch is a foamed pregelatinized starch product produced by the process of European patent application EP 0 087 847 A1.

3. The composition according to claim 1, wherein the expanded, gelatinized potato starch is obtainable from an extrusion process, wherein a starch material, preferably starch comprising potato material, is fed into an extruder, where the said material is heated in the presence of water, and optionally a gas forming expanding agent, to gelatinize the starch and to build up pressure; and when the heat processed material leaves the extruder, the pressure drop results in the formation of an extruded, i.e. gelatinized, starch structure; and the extruded material is milled or otherwise comminuted to produce the particulate, expanded, gelatinized potato starch.

4. The composition according to claim 1, wherein the agglomerates have a size such that at least 90% by weight of the agglomerates pass through a sieve with a mesh size ranging from 1 to 5 millimeter.

5. The composition according to claim 1, wherein the moisture level of the composition ranges from 2 to 10% by weight, preferably from 4 to 8% by weight.

6. The composition according to claim 1, wherein the edible solid particulate component has a size such that at least 90% by weight of the agglomerates pass through a sieve with a mesh size of 500 micrometer.

7. The composition according to claim 1, comprising from 10% by weight to 50% by weight of the particulate, expanded, gelatinized potato starch, and from 50% to 90% by weight of an edible solid particulate component.

8. The composition according to claim 1, wherein the edible solid particulate component comprises one or more compounds selected from native starches, physically modified starches, chemically modified starches, enzymatically modified starches, vegetable powders, and fruit powders.

9. The composition according to claim 8, wherein the native starch comprises one or more starches selected from corn starch, potato starch, tapioca starch, waxy corn starch, waxy rice starch, and wheat starch.

10. The composition according to claim 8, wherein the physically modified starch comprises one or more starches selected from corn starch and potato starch, preferably wherein the physically modified starch is a physically modified potato starch.

11. The composition according to claim 1, wherein the composition is free from other compounds.

12. A method for preparation of a composition according to claim 1, comprising the steps:
a) preparing a homogeneous mixture comprising from 5% by weight to 75% by weight of a particulate, expanded, gelatinized potato starch and 25% to 95% by weight of an edible solid particulate component;
b) adding water to the mixture from step a) while mixing;
c) transferring the mixture from step b) to a drier,
d) drying the mixture from step c);
e) discharging the dried and agglomerated mixture from step d) from the drier; and
f) optionally sieving and optionally packing the mixture from step e).

13. The method according to claim 12, wherein in step b) the amount of water ranges from 10% to 24% of the total amount of particulate, expanded, gelatinized potato starch and edible solid particulate component.

14. The method according to claim 12, wherein the mixing in step a) and step b) is done at a temperature ranging from 10° C. to 30° C.

15. Use of a particulate, expanded, gelatinized potato starch to improve the flowability and/or decrease dustiness and/or improve the agglomeration and/or improve the solubility of a mixture comprising an edible solid particulate component, and such particulate, expanded, gelatinized potato starch.
